(19) United States
(12) Patent Application Publication
(10) Pub. No.: US 2017/0345009 A1
(43) Pub. Date: Nov. 30, 2017

(54) Systems and Methods for Use in Facilitating Network Transactions

(71) Applicant: MASTERCARD INTERNATIONAL INCORPORATED, Purchase, NY (US)

(72) Inventor: Rick Unnerstall, O'Fallon, MO (US)

(21) Appl. No.: 15/164,735

(22) Filed: May 25, 2016

(51) Int. Cl. G06Q 20/40

(52) U.S. Cl. CPC G06Q 20/40145; G06Q 20/4016; G06Q 20/407

(57) ABSTRACT

Systems and methods are provided for facilitating network transactions. One exemplary method includes receiving, at a platform computing device, an instruction to initiate a payment account transaction at a consumer computing device and compiling an authorization request based on the instruction. The authorization request includes an account number associated with a payment account, an amount of the payment account transaction, and an identifier unique to the consumer computing device. The method also includes transmitting, by the platform computing device, the authorization request to a payment network. In another aspect, the method further includes determining, by a verification computing device, if the identifier is associated with the payment account in a verification data structure, and when the identifier is not associated with the payment account, causing the transaction to be declined.

### FIELD

The present disclosure generally relates to systems and methods for facilitating network transactions, and in particular, to appending identifiers to the transactions so that sources of the transactions (e.g., computing devices used in the transactions, etc.) can be authenticated.

### BACKGROUND

This section provides background information related to the present disclosure which is not necessarily prior art.

Merchants are known to offer various different products (e.g., goods and services, etc.) for sale to consumers. The products may be offered through physical merchant locations, or through virtual locations such as websites. When consumers interact with virtual merchant locations to purchase products, via payment accounts, the consumers are known to provide payment information to the merchants through the virtual locations, including account numbers, account expiration dates, and card verification values (CVVs), along with their names and addresses (i.e., billing and shipping addresses). Upon providing such information, the merchants facilitate transaction requests, which, in turn, are approved or declined by issuers of the payment accounts based on, for example, the standing/status of the payment accounts and available credit/funds. If approved, the transactions proceed, and the merchants cause the products to be delivered to the consumers as directed. Otherwise, if declined, the merchants terminate the transactions or request alternative forms of payment for the products.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating network transactions and verifying computing devices used to initiate such transactions;

FIG. 2 is a block diagram of a computing device that may be used in the exemplary system of FIG. 1;

FIG. 3 is an exemplary interface suitable for use in the system of FIG. 1 to register a computing device in order to verify the computing device in connection with subsequent network transactions initiated using the computing device; and

FIG. 4 is an exemplary method that may be implemented in the system of FIG. 1 for use in facilitating a network transaction and verifying a computing device used to initiate the transaction.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transactions initiated at virtual merchant locations (e.g., at websites, via network-based applications, etc.) often involve presentation of payment account information to associated merchants through the virtual locations. Because such interactions between the merchants and consumers are limited in nature, as compared to similar interactions at physical merchant locations, mechanisms available to authenticate the consumers (and the payment account information provided by the consumers) are also limited. Uniquely, the systems and methods herein permit consumers to register (or “white list”) specific computing devices to allow (or enable) the specific computing devices to be used to initiate payment account transactions to the consumers' payment accounts. In particular, the consumers register unique identifiers (or fingerprints) of the computing devices, such as, for example, media access control (MAC) addresses. In turn, when transactions are initiated at virtual merchant locations, using the registered computing devices, the identifiers of the computing devices are included in underlying transaction requests for the transactions. If the identifiers are verified, the transactions are permitted to proceed. But if the identifiers are not verified, the transactions may be declined. In this manner, the systems and methods herein provide an additional mechanism for authorizing transactions (and authenticating the consumers initiating the transactions), whereby risks associated with fraudulent transactions based on information from compromised payment accounts can be reduced.

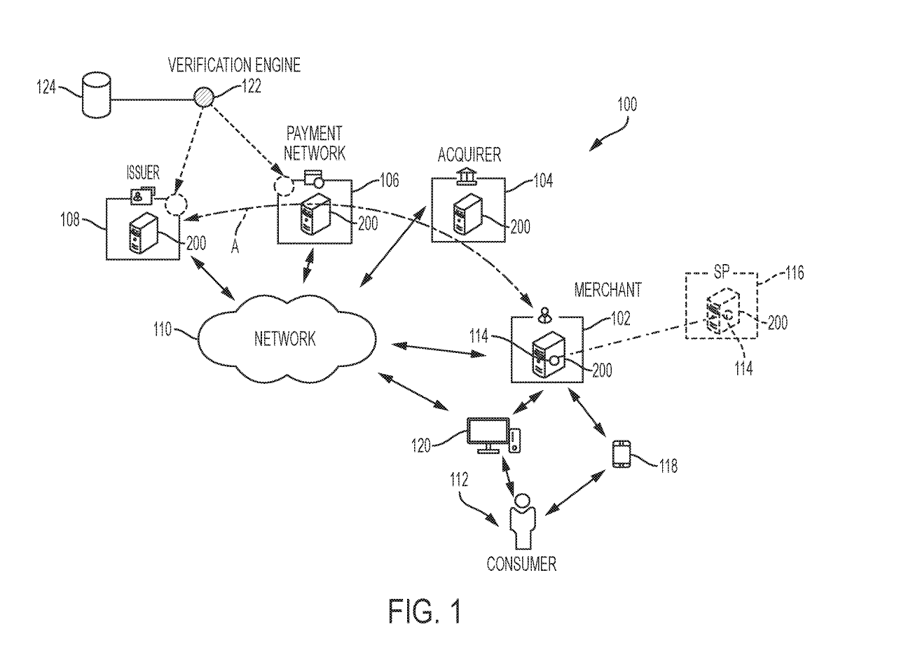

FIG. 1 illustrates an exemplary system 100, in which the one or more aspects of the present disclosure may be implemented. Although the system 100 is presented in one arrangement, other embodiments may include systems arranged otherwise depending, for example, on the manner of in which virtual merchant locations are implemented, the manner in which payment account transactions are processed, etc.

In the illustrated embodiment, the system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which is accessible as desired to the merchant 102, the payment network 106, the issuer 108, and one or more various consumers in the system 100, etc.

The merchant 102 in the system 100 is generally associated with products (e.g., goods and/or services, etc.) for purchase by one or more consumers (including consumer 112). The merchant 102 offers the products for sale through a network-based platform 114 (broadly, a virtual merchant location for the merchant 102 defined by executable instructions, for example). The network-based platform 114 may include, for example, a website (or multiple websites), a network-based application (or multiple applications), etc. In use, the network-based platform 114 permits consumers (including consumer 112) to locate products offered by the merchant 102, browse products, view selected products including details and/or images of the products, and further to purchase the products from the merchant 102, as desired. When the consumer 112, for example, purchases a product from the merchant 102, the network-based platform 114 may directly coordinate the receipt of payment information from the consumer 112 (e.g., billing address, primary account number (PAN), account expiration date, etc.), or it may invoke a another suitable network-based platform, such as, for example, an application program interface (API), or the like, for such purposes.

In FIG. 1, the network-based platform 114 associated with the merchant 102 is generally illustrated as included in/provided by the merchant 102. However, as indicated by the dotted lines, the network-based platform 114 may be provided to (or on behalf of) the merchant 102 by a separate service provider 116. As such, it should be appreciated that, when the merchant's network-based platform 114 is referred to herein as performing an operation, it may be performed directly by the merchant 102, by the service provider 116, or through one or more APIs apart from the merchant 102 and/or the service provider 116, or the like.

As described, the consumer 112 can interact with the merchant 102, and more specifically, with the network-based platform 114, to purchase one or more products from the merchant 102. As shown, the consumer 112 is associated with a communication device 118 and a computing device 120, which are configured to communicate with the merchant 102 (and specifically, the network-based platform 114) and/or otherwise, via the network 110. The consumer 112 is further associated with a payment account, which can be used to fund transactions for the purchase of products from the merchant 102, for example. The payment account is generally represented by one or more payment devices (e.g., payment cards, fobs, virtual payment devices contained in an electronic wallet, etc.) that include identifying information about the consumer's payment account such as, for example, a PAN, expiration date, card verification value (CVV), consumer name, etc.

While one merchant 102, one acquirer 104, one payment network 106, one issuer 108, one consumer 112, one communication device 118, and one computing device 120 are illustrated in FIG. 1, it should be appreciated that any number of these entities/devices (and their associated components) may be included in the system 100, or may be included as a part of systems in other embodiments, consistent with the present disclosure.

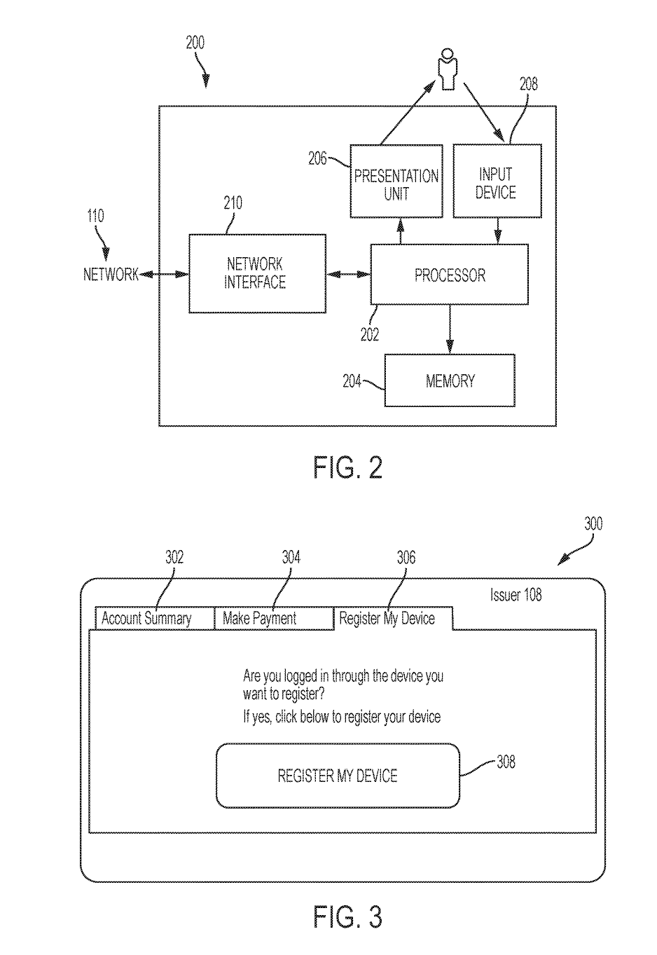

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, the issuer 108, and the service provider 116 are illustrated as including, or being implemented in, computing device 200, coupled to the network 110. In addition, devices 118, 120, which are associated with consumer 112, can also each be considered a computing device consistent with computing device 200 for purposes of the description herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, consumer profiles, computing device identifiers, payment account information, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., product information, registration options, purchase information, verification/authentication information, etc.), either visually or audibly to a user of the computing device 200, for example, the consumer 112 in the system 100, users associated with other parts of the system 100, etc. Various interfaces (e.g., as defined by network-based applications, webpages, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of registration options, etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 110. It should further be understood that, in some exemplary embodiments, the computing device 200 includes the processor 202 and one or more network interfaces incorporated into or with the processor 202.

Further, the network interface 210 of the computing device 200 is assigned (e.g., includes, etc.) an address or identifier utilized to communicate via one or more networks (e.g., Ethernet, IEEE 802 networks (e.g., 802.11 wireless networks, etc.), Bluetooth, fiber distribution data interfaces (FDDIs), etc.), which may include, for example, network 110. The identifier is generally unique to the computing device 200 (for example, representing a fingerprint of the computing device 200, etc.), and may include a media access control (MAC) address, which is a physical, static address for the network interface 210, and by extension, the computing device 200. An identifier may also (or alternatively) include an Internet protocol (IP) address associated with the computing device 200 (when sufficiently static for the purposes herein). In various embodiments, an identifier of the computing device 200 may further include attributes of the computing device 200 in addition to (or other than) the MAC address and/or the IP address, such that the resulting identifier is sufficiently unique to the computing device 200 (e.g., to generally fingerprint the computing device 200, or to fingerprint a set of computing devices, etc.) to support the operations described herein. For example, the identifier may be indicative of, without limitation, one or more of the MAC address, the IP address, a public IP (port), IP details, an operating system, a user agent browser, a user agent operating system, a screen resolution (broadly, a graphics capability), a server timestamp, a location (e.g., a city name, a country name, etc.), a connection speed, a connection type, an IP routing type, a carrier name, a processor core, an autonomous system number (ASN), a top-level domain, a second-level domain, a client timestamp, a browser geolocation, an IP geolocation, a transmission control protocol synchronization (TCP SYN) packet signature, (domain name system) DNS data, script data, display data, a request header, a plugin list, a predetermined “geofence” area, cookies enabled, etc. It should, of course, be appreciated that certain identifiers may be unique to the computing device 200, while other identifiers are unique to a set of computing devices 200 (but still exclude certain computing devices). Further, it should be appreciated that the identifiers may be different, depending on, for example, the type of computing device 200 (e.g., laptop versus smartphone, etc.). Thus, a single identifier or multiple identifiers together may then represent the unique fingerprint of the computing device 200.

Referring again to FIG. 1, the system 100 also includes a verification engine 122, which is specifically configured, by executable instructions, to perform one or more of the operations herein. As to capturing certain types of identifiers, for example, executable instructions implemented in connection with the verification engine 122 may include, for example (and without limitation), one or more of the instructions found at: http://www.darkwavetech.com/fingerprint/fingerprint_code.html; https://www.augur.io/; and http://stackoverflow.com/questions/850650/reliable-method-to-get-machines-mac-addres s-in-c-sharp. It should be appreciated that further executable instructions related to the operations described herein can be readily derived, by those skilled in the art, given the content of the present disclosure.

As shown in FIG. 1, the verification engine 122 is illustrated apart from the payment network 106 and the issuer 108, but, as indicated by the dotted lines, may be incorporated, in whole or in part, with either. In other embodiments, however, it should be appreciated that the verification engine 122 may be incorporated with other parts of the system 100 (e.g., the acquirer 104, etc.). In general, the verification engine 122 may be implemented and/or located, based on where, in path A, for example, an authorization request for a payment account transaction is evaluated/verified/authenticated, as described herein, etc. As such, the system 100 can utilize traditional processing of payment account transactions to facilitate the stepped-up authentication described herein (e.g., verification of a fingerprint of one of devices 118, 120 used in a payment account transaction, etc.). In connection therewith, no other devices could originate a payment account transaction to the consumer's account.

In general in the system 100 (and with respect to the consumer 112), the verification engine 122 is configured to initially register selected ones of the devices 118, 120 with the consumer 112 and/or with the consumer's payment account (such that the devices 118, 120 can subsequently be correlated to the consumer's payment account). For example, in the following description, the verification engine 122 is configured to register communication device 118. In connection therewith, the consumer 112 can then identify the communication device 118 to the verification engine 122, essentially allowing the engine 122 to assign a unique fingerprint to the communication device 118 (e.g., via the identifier(s) for the communication device 118, etc.). Through such registration, the verification engine 122 can subsequently verify transactions initiated at the computing device 118 and involving the consumer's payment account as appropriate, or not.

More particularly, in connection with registering the communication device 118, the verification engine 122 is configured to capture the identifier(s) (e.g., the MAC address, the IP address, other machine attributes, combinations thereof, etc.) for the communication device 118. Specifically, when communicating with the verification engine 122 during registration, the communication device 118 provides certain details about itself to establish a “session” with the verification engine 122. Through the session, information, data, interfaces, responses, etc. is/are exchanged between the communication device 118 and the verification engine 122, including, for example, the identifier(s) for the communication device 118.

For example, the verification engine 122 may utilize Address Resolution Protocol (ARP) to resolve and track the TCP/IP address and/or MAC address of the communication device 118 (e.g., in connection with performing semi-low level network troubleshooting, granting or denying permissions to a network segment or the device 118 on such network, etc.). In particular, the verification engine 122 may identify the MAC address of the communication device 118 by pinging the communication device 118 (e.g., launch a MS-DOS prompt, enter a command “CMD”, enter a command to PING 192.168.0.1, and enter a command “ARP-A”; etc.). Additionally, or alternatively, other operations may be used to identify the MAC address and/or other desired attributes for the communication device 118 (e.g., conventional communication with the communication device 118 may be used to identify screen resolution, etc.). The MAC address, then, is the unique device ID for the communication device 118 and may be coupled with one or more other machine attributes of the communication device 118 (e.g., screen resolution, etc.) to create a device fingerprint for the communication device 118.

Once the identifier(s) is/are captured, the verification engine 122 is configured to store the identifier(s) in verification data structure 124. The identifier(s) may be stored in the verification data structure 124 in association with a consumer profile for the consumer 112 and/or a consumer profile for the consumer's payment account. In either case, the PAN for the consumer's payment account is then also appended to the verification data structure 124 in association with the identifier(s), so that a link can be established between the identifier(s) (and, the communication device 118) and the consumer's payment account. For example, the identifier(s) may be stored in the verification data structure 124 in association with an identification associated with the consumer 112 such as a name, ID number, etc., and further in association with the PAN for the consumer's payment account. It should be appreciated that the verification data structure 124 may be separate from the verification engine 122, or it may be included in memory 204 associated with the verification engine 122, etc.

In addition, the verification engine 122 is also configured to capture geographic information related to the communication device 118, in connection with the registration. The verification engine 122 may be configured to capture, for example, without limitation, a latitude/longitude, accuracy radius, lookup timestamp(s), continent, country, region, state, city, area code, metro code, postal code, time zone, etc. related to the communication device 118. The verification engine 122 may be configured to gather such information directly from the communication device 118, or from an intermediate part of the network 110, and to transmit the information to a location service provider (not shown), which employs conventional techniques to provide the communication device's location or approximate location back to the engine 122 In at least one embodiment, the verification engine 122 is configured to interact with the communication device 118, and specifically, the consumer 112, whereby the consumer identifies and/or creates a “geofence” (broadly, geographic information) that defines an area in which transactions are permitted using the communication device 118. As will be described, in addition to using the identifier(s) for the communication device 118, the verification engine 122 may then also use a current location of the communication device 118 as a basis to verify, or not, a payment account transaction (e.g., the engine 122 may only verify the transaction if the current location of the transaction is consistent with the previously captured geographic information for the device 118 and/or created “geofence”, etc.).

Further, the verification engine 122 may be configured to require biometric authentication, prior to registering the communication device 118 to the verification data structure 124. Specifically, for example, the verification data structure 124 may include a biometric reference for the consumer 112, which may include, without limitation, a fingerprint data, iris data, palm data, retina data, hand data, DNA data, and/or facial reference data, or other suitable biometric data related to the consumer 112, and which (given an appropriate input device 208) can be obtained from the consumer 112 at the communication device 118 and provided to the verification engine 122. In turn, the verification engine 122 is configured to compare the biometric data obtained from the consumer 112 to the reference data stored in the verification data structure 124. If a match is determined, the verification engine 122 is further configured to permit the registration of the communication device 118 into the verification data structure 124. It should be appreciated that biometric authentication may be employed in some embodiments, but not others.

A similar process may be used to register the consumer's computing device 120, as desired, as well as other computing devices for other consumers in the system 100. As such, the verification engine 122 essentially “white lists” the consumer's devices 118, 120 so that they can be used in payment account transactions by the consumer 112, in accordance with any restrictions, limitations, or other instructions potentially implemented by the consumer 112 for such use (e.g., for all of the devices 118, 120, or for select ones of the devices 118, 120; etc.), as described herein (e.g., to facilitate the stepped-up authentication in real time, etc.).

FIG. 3 illustrates an example registration interface 300 that may be used in the system 100, by the verification engine 122, to initially register the consumer's communication device 118, for example. In connection therewith, the verification engine 122 is configured to cause the interface 300 to be displayed at the communication device 118, for view by the consumer 112 (e.g., as part of a website or network-based application, or the like, etc.). It should be appreciated that the registration interface 300 is merely exemplary in nature, and that other interfaces having other configurations may be used to register devices in other embodiments.

In this example, the registration interface 300 forms part of an account access interface for the consumer 112, offered by the issuer 108. As such, through the interface 300, the consumer 112 is able select a desired one of tabs 302, 304 to access and view account information for his/her payment account and make payments, as desired. In addition, the interface 300 includes a “Register My Device” tab 306 (which is shown selected in FIG. 3). Through selection of the tab 306, the consumer 112 is able to confirm that the communication device 118 is to be registered (i.e., that the consumer 112 is currently accessing the interface 300 through the communication device 118) and, using button 308, to actually register the device 118. In response (i.e., in response to selection of the button 308), the verification engine 122 is configured to then capture the identifier (or multiple identifiers) of the communication device 118, and store the identifier(s) in the verification data structure 124 in association with the consumer 112.

While the above is described in connection with registering the one communication device 118 to the registration engine 122, the system 100 can facilitate registration of multiple devices, as desired. For example, the communication 118 associated with the consumer 112 may include a mobile device and the computing device 120 may include a desktop computing device. The consumer 112 may use both devices 118, 120 to initiate purchases with the merchant 102 (e.g., device 118 when away from home and device 120 when at home, etc.) and, as such, may desire to register both devices with the registration engine 122. As another example, a parent may register multiple different computing devices for his/her family (e.g., mobile devices, laptop computers, etc. for himself/herself, for a spouse, and for kids; etc.). In this manner, the parent can limit spending to an associated payment account to the registered devices in a geo-specific area.

With continued reference to FIG. 1, the network-based platform 114 associated with the merchant 102 is configured to interact with the consumer 112, via the communication device 118, to initiate a payment account transaction for purchase of products by the consumer 112 from the merchant 102 (using the communication device 118 (as an origination computing device)). Specifically, upon selection of a product through the platform 114 (using the communication device 118), the consumer 112 can select to purchase the product, whereupon the consumer 112 is prompted to enter payment account information to fund the transaction through the consumer's payment account. Then, upon selection of a “checkout” or similar option, the platform 114 is configured to initiate the payment account transaction.

Once the payment account transaction is initiated by the consumer 112, the network-based platform 114 is configured to compile an authorization request for the transaction. Uniquely, in connection with compiling the authorization request, the platform 114 is configured to determine the identifier(s) associated with the communication device 118 (through which the consumer 112 is making the transaction) and append the identifier(s) to the authorization request. The network-based platform 114 is configured to then transmit the compiled authorization request to the acquirer 104, consistent with path A in the system 100. The acquirer 104, in turn, communicates the authorization request to the issuer 108 (i.e., the issuer of the consumer's payment account), through the payment network 106, such as, for example, through MasterCard®, VISA®, Discover®, American Express®, etc.

In route, or upon receipt of the authorization request at the issuer 108, the verification engine 122 is configured to inspect the authorization request to determine if an identifier (or if multiple identifiers) for a computing device is present, or not. Upon determining that an identifier is present, the verification engine 122 is configured to compare it to the identifier for the communication device 118 stored in the data structure 124 in association with the payment account indicated in the authorization request. If the identifier is a match, the verification engine 122 is configured to permit the transaction to proceed (broadly, verify the transaction and/or authenticate the consumer 112), in which case the issuer 108 determines if the payment account is in good standing and/or whether there is sufficient credit or funds to complete the transaction, etc. If the issuer 108 accepts the transaction, an authorization reply authorizing the transaction is provided back to the acquirer 104 and the merchant 102, thereby permitting the merchant 102 to complete the transaction (via the platform 114). The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108) (through further communication therebetween).

Conversely, if the verification engine 122 fails to find an identifier in the authorization message for a computing device, or fails to verify the identifier included in the authorization message in the data structure 122, the verification engine 122 is configured to cause the transaction to be declined. In turn, for this reason, or based on the issuer 108 declining the transaction for other reasons, an authorization reply declining the transaction is provided back to the merchant 102, consistent with path A, thereby permitting the merchant 102 to halt the transaction and/or seek alternate means of payment. It should be appreciated that the verification engine 122 is further configured to ignore the authorization message, when the associated account is not registered to the verification engine 122, or otherwise not set up to be subject to communication device identifier verification.

Transaction data is generated, collected, and stored as part of the above interactions among the merchant 102, the acquirer 104, the payment network 106, the issuer 108, and the consumer 112. The transaction data represents at least a plurality of transactions, for example, authorized transactions, cleared transactions, attempted transactions, etc. The transaction data, in this exemplary embodiment, is stored at least by the payment network 106 (e.g., in a data structure associated with the payment network 106, etc.). Such transaction data, in this embodiment, may include, for example, device identifiers, payment account numbers, amounts of the transactions, merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

In various exemplary embodiments, the consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to gather and/or use data collected during enrollment and/or collected in connection with processing the transactions, subsequently for one or more of the different purposes described herein.

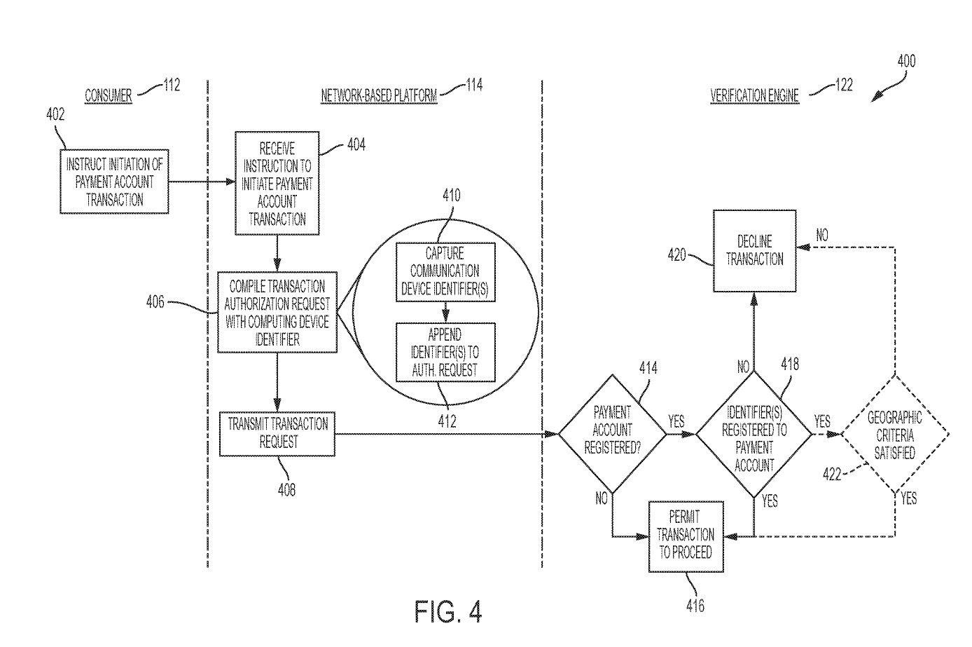

FIG. 4 illustrates an exemplary method 400 for verifying payment account transactions, through use of identifiers for registered computing devices used to initiate the payment account transactions. The exemplary method 400 is described as implemented in the verification engine 122, and in the network-based platform 114 at the communication device 118 associated with consumer 112. However, it should be understood that the method 400 is not limited to this configuration of the verification engine 122 or the portable communication device 118, as the method 400 may be implemented, at least in part, in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 400.

In the method 400, the communication device 118 is associated with an identifier, which is a MAC address for the communication device 118 and which is registered to the verification engine 122 (as described in connection with the system 100) and stored in the verification data structure 124. Likewise, the computing device 120 is associated with an identifier, which is a MAC address for the device 120 and which is also registered to the verification engine 122. It should be appreciated that the devices 118, 120 may also be associated with other identifiers (e.g., other machine attributes, etc.) that may be registered, or not, to the verification engine 122, and which potentially (either alone or in combination with the MAC address, for example) define fingerprints for the respective devices 118, 120.

As shown in FIG. 4, in connection with purchasing a product at the merchant 102 via the network-based platform 114, the consumer 112 initiates a payment account transaction for the product. As part of the transaction, the consumer 112 provides a purchase instruction to the network-based platform 114, at 402, via the communication device 118 (i.e., the computing device used by the consumer to initiate the transaction). For example, after the consumer 112 identifies the product for purchase and enters relevant and/or necessary payment account information (e.g., a PAN, an expiration date for the account, a billing address, a shipping address, etc.), the consumer 112 may select an “Order” button displayed by the network-based platform 114, as an input to the communication device 118, when checking out.

In response, the network-based platform 114 receives the instruction regarding the payment account transaction from the consumer 112, at 404 (and more particularly, from the consumer's communication device 118). The platform 114 then compiles an authorization request for the transaction, at 406, and transmits the authorization request to the acquirer 104 (consistent with path A in FIG. 1), at 408. As part of compiling the authorization request, the platform 114 captures the identifier(s) for the communication device 118, at 410 (e.g., the MAC address, other machine attributers, etc.), and appends the identifier(s) to the authentication request, at 412. The identifier(s) may be captured actively, or passively, by the verification engine 122, for example, depending on the identifier(s).

As a passive example (e.g., for capturing identifiers other than the MAC address, such as screen resolution; etc.), the authorization request compiled by the network-based platform 114 may include a message consistent with the ISO 8583 standard. Here, when communicating with the platform 114 in connection with effecting the payment account transaction for the product at the merchant 102, certain information about the communication device 118 is provided to the platform 114 as part of conventional communication, to establish a “session” with the platform 114 (e.g., information that is readily available and used routinely by browsers on the device 118, etc.). Therefore, through the session, the platform 114 is able to passively capture the information in a conventional manner (e.g., including an operating system fingerprint, IEEE 802.11 (wireless) setting, a TCP/IP configuration, a hardware clock skew, etc.) as it is exchanged between the communication device 118 and the platform 114, which in turn may be used as an identifier (or as multiple identifiers) for the communication device 118 (e.g., as part of the fingerprint for the device 118, etc.). The platform 114 may then append the identifier(s) to the authorization request by including it/them in a data element of the message, for example, at one or more unused data elements of 0100 and/or 0200 messages per the ISO 8583 standard. It should be appreciated that the network-based platform 114 may appended the identifier(s) to any available or suitable data element(s), or Subelement(s), in the compiled acknowledgement request message consistent with the ISO 8583 standard, or with some other suitable standard, as used.

Conversely, when the capture of the identifier is active (e.g., for the MAC address, etc.), the exemplary platform 114 queries the communication device 118 to determine the identifier associated therewith. Specifically, for example, as described above in the system 100, the verification engine 122 may utilize ARP to resolve and track the MAC address of the communication device 118 (e.g., in connection with performing semi-low level network troubleshooting, granting or denying permissions to a network segment or the device 118 on such network, etc.). In particular, the verification engine 122 may identify the MAC address of the communication device 118 by pinging the communication device 118 (e.g., by launching a MS-DOS prompt, generating a command “CMD”, generating a command PING 192.168.0.1, and generating a command “ARP-A”; etc.). Like above, once the platform 114 has captured the identifier, the platform 114 may then append the identifier to the authorization request, at one or more of its unused data elements.

In various embodiments, an application may be installed on the communication device 118, for example, upon registration of the device 118 with the verification engine 122. Various identifiers (e.g., attributers, etc.) regarding the communication device 118 may then be collected by the application and communicated to the verification engine 122, as appropriate, to accomplish the various operations described herein.

Further, in some embodiments, prior to being appended to the authorization request, the identifiers for the communication device 118, once captured by the network application 114, may be subjected to one or more coding and/or encryption techniques (e.g., a one-way hash function (e.g., SHA-256, etc.), etc.), so that the identifiers are obfuscated and indeterminate.

With continued reference to FIG. 4, as the authorization request is transmitted within the system 100 along path A, the verification engine 122 detects the authorization request (e.g., at the payment network 106, at the issuer 108, at another location along path A, etc.), and determines, at 414, if the payment account identified in the request is registered for verification. Specifically in the method 400, the verification engine 122 compares the PAN included in the authorization request (for the payment account used in the underlying transaction) to a listing of PANs for registered payment accounts stored in the data structure 124. If the PAN is not included in the data structure 124, the verification engine 122 permits the transaction to proceed for authorization, at 416, as is conventional.

Conversely, if the PAN is included in the data structure 122, the verification engine 122 determines if the identifier(s) included in the authorization request is/are registered to the corresponding payment account included in the data structure 122, at 418. If the identifier(s) is/are registered, the verification engine 122 permits the transaction to proceed, at 416, as is conventional. However, if the identifier(s) is/are not registered, the verification engine 122 causes the transaction to be declined, at 420, whereby an authorization reply declining the transaction is generated, by the issuer 108 and/or the verification engine 122, and transmitted, for example, to the merchant 102.

Optionally, as indicated by the dotted lines in FIG. 4, the verification engine 122 may further determine whether geographic criteria, associated with the consumer's payment account, is satisfied, at 422. Specifically, for example, when the consumer 112 defines a geofence for the communication device 118, the platform 114 further captures, at 410, and appends, at 412, geographic information pertaining to the communication device 118 to the authorization request. In turn, the verification engine 122, in addition to determining whether the identifier(s) is/are registered to the payment account, at 418, further determines whether the geographic information contained in the authorization request indicates a location within the geofence defined by the consumer (broadly, satisfies the consumer's predefined geographic criteria). If yes, the verification engine 122 permits the transaction to proceed, at 416, but if not, the engine 122 declines the transaction, at 420. Similarly, where a geographic identifier is provided when registering the communication device 118, and associating the device 118 with the payment account, the verification engine 122 further determines, at 422, whether the geographic information contained in the authorization request is consistent with the geographic identifier previously provided (broadly, satisfies the consumer's predefined geographic criteria). Again, if yes, the verification engine 122 permits the transaction to proceed, at 416, and if no, declines the transaction, at 420.

It should be appreciated that geographic information and/or geographic criteria may be employed in a variety of different manners, where the verification engine 122 determines whether to permit the transaction to proceed, or not, based on the same.

In some embodiments, tokenization may be used in connection with identifiers captured for the communication device 118 (or the communication device 120). For example, when registering the communication device 118 to the verification engine 122, the verification engine 122 may generate a token for the captured identifiers and store the token in the data structure 124 (i.e., map the identifiers to the token). Similarly, upon capturing identifiers from the computing device 118 during a payment account transaction, the identifiers may be tokenized prior to (or after) inclusion in the authentication request, to simplify and speed up the process for future transactions. In so doing, the token generally includes (or generally represents) a summation of the identifiers used to uniquely authenticate the communication device 118 (and, thus, the corresponding consumer 112). For example, following the above transaction by the consumer 112, the identifier(s) for the communication device 118 used in the transaction may initially be subjected to one or more coding and/or encryption techniques (e.g., a one-way hash function (e.g., SHA-256, etc.), etc.), at the network-based platform 114, for example, so that the identifier(s) are obfuscated and indeterminate when included in the authorization request. Then, once received by the verification engine 122 (e.g., at the payment network 106, etc.), for example, the identifier(s) are determined from the authorization request and are assigned to the PAN for the consumer's account, and a unique token is created for the PAN (and for the identifier(s)). The token can then be subsequently used for seamless authentication and authorization in the future at the communication device 118.

Further, in various embodiments, other criteria (broadly, other transaction criteria) may be provided and/or defined by the consumer 112 upon registering one of the devices 118, 120 with the verification engine 122, for example, to limit use of the devices 118, 120 to particular types of transactions. For example, the consumer 112 may provide additional criteria relating to transaction amounts, such that transactions involving the consumer's portable communication device 118 under a predefined value are permitted to proceed (e.g., transactions below $20.00, below $50.00, etc.), but transactions above the predefined value are declined. Similar criteria may be provide by the consumer 112 relating to particular merchants, MCCs, days/times of transactions, etc. In the same example, the consumer may then register the computing device 120 for unlimited transactions. In so doing, the consumer 112 can not only limit certain ones of the devices 118, 120 to certain transactions, but may effectively designate certain ones of the devices 118, 120 as available for only certain transactions.

In view of the above, the systems and methods herein may permit verification of a communication device originating a transaction to a registered payment account. In this manner, the systems and methods provide an additional mechanism for authorizing transactions (and authenticating the consumers initiating the transactions), whereby risks associated with fraudulent transactions based on information from compromised payment accounts can be reduced.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an instruction to initiate a payment account transaction at a consumer computing device; (b) compiling an authorization request based on the instruction, the authorization request including an account number associated with a payment account, an amount of the payment account transaction, and at least one identifier unique to the consumer computing device; (c) transmitting the authorization request to a payment network, such that the transaction is verified based on the at least one identifier when the at least one identifier is registered to the payment account; and (d) declining the payment account transaction, in response to an authorization reply from an issuer of the payment account, when the at least one identifier is not registered to the payment account.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an authorization request for a transaction to a payment account involving a merchant, the authorization request including at least one identifier associated with an origination computing device used by a consumer to initiate the transaction; (b) determining if the at least one identifier is associated with the payment account in a verification data structure; (c) when the at least one identifier is not associated with the payment account, causing the transaction to be declined, thereby restricting transactions that can be initiated at the origination computing device to those involving the payment account associated with the consumer; and (d) when the at least one identifier is associated with the payment account in the verification data structure, causing the transaction to be verified and permitting the transaction to proceed for authorization by an issuer of the consumer's payment account.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

As used herein, a token (e.g., a payment token, etc.) generally is an electronic data set that includes credentials that may be used in a purchase transaction in place of traditional payment credentials. Typically, the credentials for the token are uniquely associated to a computing device (e.g., a portable communication device, etc.), for example, to which the token is provisioned. Because the token is directly associated to the computing device, theft of the token may be inconsequential to the user, since the token is unusable if not used in conjunction with the proper computing device. Thus, the use of the token can enable electronic payment transactions involving the computing device with greater security without a sacrifice to efficiency or convenience. The systems and methods herein thus may also include, as appropriate, generating and/or assigning the tokens to consumers and provisioning the tokens to computing devices associated with the consumers.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating network transactions, the method comprising:
receiving, at a platform computing device, an instruction to initiate a payment account transaction at a consumer computing device;
compiling, at the platform computing device, an authorization request based on the instruction, the authorization request including an account number associated with a payment account, an amount of the payment account transaction, and at least one identifier unique to the consumer computing device; and
transmitting, by the platform computing device, the authorization request to a payment network, such that the transaction is verified based on the at least one identifier when the at least one identifier is registered to the payment account.

2. The computer-implemented method of claim 1, wherein the at least one identifier includes one or more of a media access control (MAC) address and an Internet protocol (IP) address of the consumer computing device.

3. The computer-implemented method of claim 2, wherein compiling the authorization request includes capturing the at least one identifier from the consumer computing device.

4. The computer-implemented method of claim 3, wherein compiling the authorization request further includes capturing a geographic location of the consumer computing device; and
wherein the authorization request further includes the captured geographic location.

5. The computer-implemented method of claim 1, further comprising declining the payment account transaction, in response to an authorization reply from an issuer of the payment account, when the at least one identifier is not registered to the payment account.

6. The computer-implemented method of claim 1, wherein the authorization request includes a message consistent with the ISO 8583 standard; and
wherein compiling the authorization request includes appending the at least one identifier to at least one data element of the message.

7. A computer-implemented method for use in facilitating network transactions, the method comprising:
receiving, at a verification computing device, an authorization request for a transaction to a payment account involving a merchant, the authorization request including at least one identifier associated with an origination computing device used by a consumer to initiate the transaction;
determining, by the verification computing device, whether the at least one identifier is associated with the payment account in a verification data structure; and
when the at least one identifier is not associated with the payment account, causing, by the verification computing device, the transaction to be declined, thereby restricting transactions that can be initiated at the origination computing device to those involving the payment account associated with the consumer.

8. The computer-implemented method of claim 7, wherein the at least one identifier includes one or more of a media access control (MAC) address and an Internet protocol (IP) address of the consumer computing device.

9. The computer-implement method of claim 8, further comprising, when the at least one identifier is associated with the payment account in the verification data structure, causing, by the verification computing device, the transaction to be verified and permitting the transaction to proceed for authorization by an issuer of the consumer's payment account.

10. The computer-implemented method of claim 8, wherein receiving an authorization request includes identifying the authorization request, after the authorization request is transmitted by the merchant to a payment network for authorization.

11. The computer-implemented method of claim 8, wherein determining whether the at least one identifier is associated with the payment account in a verification data structure includes comparing a primary account number (PAN) for the consumer's payment account to a listing of PANs in the verification data structure for registered payment accounts.

12. A system for use in facilitating payment account transactions, the system comprising:
a processor; and
a memory coupled to the processor and including a verification engine defined by executable instructions, which when executed by the processor, cause the processor to:
detect an authorization request for a payment account transaction, the authorization request including a fingerprint associated with a computing device used by the consumer to initiate the transaction;
extract the fingerprint from the authorization request and compare the fingerprint to a payment account profile, the payment account profile including at least one registered identifier for the consumer's computing device; and
when the fingerprint fails to match the at least one registered identifier, cause the payment account transaction to be declined, whereby the payment account is limited, for network transactions initiated by the consume at the computing device, to transactions initiated at the computing device registered to the payment account profile.

13. The system of claim 12, wherein the authorization request includes geographic data related to the consumer's computing device at the time said payment account transaction was initiated;
wherein the payment account profile further includes a geographic criteria, defined by the consumer; and
wherein the executable instructions defining the verification engine, when executed by the processor, further cause the processor to cause the payment account transaction to be declined when the geographic data fails to satisfy the geographic criteria.

14. The system of claim 13, wherein the processor and the memory are included in an issuer computing device.

15. The system of claim 12, wherein the consumer is associated with the payment account; and
wherein the executable instructions defining the verification engine, when executed by the processor, further cause the processor to register at least one additional identifier for the consumer's computing device to the payment account and store the at least one additional identifier as part of the payment account profile, when the consumer is authenticated in connection with the payment account transaction.

16. The system of claim 12, wherein the fingerprint includes one or more of a screen resolution for the consumer's computing device, an operating system for the consumer's computing device, an Internet protocol (IP) routing type for the consumer's computing device, a public IP (port) for the consumer's computing device, and a top-level domain for the consumer's computing device.

17. The system of claim 12, wherein the fingerprint further includes geographic data related to the computing device used by the consumer to initiate the transaction.

18. The system of claim 12, wherein the processor is a first processor; and
further comprising a computer readable media including a network-based platform defined by executable instructions, which, when executed by a second processor, cause the second processor to:
capture the fingerprint from the computing device used by the consumer to initiate the payment account transaction; and
append the fingerprint to the authorization request.

19. The system of claim 18, wherein the first processor is different from the second processor; and
wherein the executable instructions defining the network-based platform, when executed by the second processor, further cause the second processor to append geographic information to the authorization request based on a location of the consumer's computing device when initiating the payment account transaction, in addition to the fingerprint.

20. The system of claim 18, wherein the authorization request includes a message consistent with the ISO 8583 standard; and
wherein the executable instructions defining the verification engine, when executed by the processor, cause the processor to append the fingerprint to at least one data element of the message.
